(19) United States
(12) Patent Application Publication
(10) Pub. No.: US 2016/0110041 A1
(43) Pub. Date: Apr. 21, 2016

(54) SYSTEMS AND METHODS FOR SELECTING AND DISPLAYING IDENTIFIED OBJECTS WITHIN VIDEO CONTENT ALONG WITH INFORMATION ASSOCIATED WITH THE IDENTIFIED OBJECTS

(71) Applicant: APERTURE INVESTMENTS, LLC, Mercer Island, WA (US)

(72) Inventor: Jacquelyn FUZELL-CASEY, Mercer Island, WA (US)

(21) Appl. No.: 14/984,797

(22) Filed: Dec. 30, 2015

Related U.S. Application Data
(63) Continuation-in-part of application No. 13/828,656, filed on Mar. 14, 2013.
(60) Provisional application No. 62/099,053, filed on Dec. 31, 2014.

(51) Int. Cl. G06F 3/0482; G11B 27/34; G11B 27/30; G06F 3/0484; H04N 5/272

(52) U.S. Cl. CPC G06F 3/0482; G06F 3/04842; H04N 5/272; G11B 27/3081; G11B 27/34

(57) ABSTRACT

Systems and methods for identifying objects, such as advertised items or other content, within video content, which may be sequitur or non-sequitur in nature. The identified objects may then be select from within video content by a user to access metadata associated with the objects. The identified objects may be identified to viewers by cues. Cues may be oral, visual or both oral and visual. One or more frames corresponding to a period of video depicting identified objects are displayed in separate object identifiers that may be viewed by the viewer and from within which the identified objects may be selected by the viewer.

### RELATED APPLICATIONS

This application claims benefit under 35 U.S.C. §119(e) of Provisional U.S. Patent Application No. 62/099,053, filed Dec. 31, 2014, the contents of which is incorporated herein by reference in its entirety.

This application is a continuation-in-part of U.S. patent application Ser. No. 13/828,656, filed Mar. 14, 2013, the entirety of which is incorporated herein by reference.

### BACKGROUND

During the creation of video content, especially video content that is mood-based or directed to a particular view segment, such as youths, many different items are likely to appear in the video content at different times. Some of this content may include advertising placements or other metadata, where certain branded or producer-identifiable items are purposely placed in the video in order to possibly draw attention to those items. For example, a video may include images of characters drinking beer in a room, where the beer label is that of a particular company. Whether a viewer recognizes the label or is influenced by that recognition in anyway is hard to say, but a huge amount of money has been spent making such placements.

Of course, creating video content that purposely includes branded or producer-identifiable items creates significant additional costs and complications. If the video is created first, with items chosen by the video creator, and then the brand owner or producer of the item is approached about the placement, the brander/producer may not like the video, may not like how the item is placed, or simply not be interested in advertising. Since the video has already been shot, it may be difficult to impossible to alter the item to make it appear to be someone else's product. Using the above example, it may be possible and relatively inexpensive to use computer-generated imagery (CGI) to change the label on a beer can, but it may be harder or impossible to cost-effectively change one specially shaped bottle for something else. If the item cannot be economically changed, it may not be possible to get other brand owners or producers to place their ads in association with another brand's/producer's product. If the brand owner or producer is approached up front, before the video is produced, their demands may make it economically infeasible to produce the video as desired.

### SUMMARY

Systems and methods for identifying integrated objects, such as advertised items or other content, within video content, which may be sequitur or non-sequitur in nature, are disclosed. In addition, systems and methods are disclosed for enabling viewers to select integrated objects within video content to access information associated with the objects that does not need to interfere with the video being watched in any meaningful way.

### BRIEF DESCRIPTION OF THE DRAWINGS

Throughout the drawings, reference numbers are re-used to indicate correspondence between referenced elements. The drawings are provided to illustrate embodiments of the inventive subject matter described herein and not to limit the scope thereof.

FIG. 1 illustrates an embodiment of a video segmentation grid applied over a video display area for identifying selectable objects associated with information appearing in video displayed in the video display area;

FIG. 2 illustrates an embodiment of a viewing screen containing a video display window for displaying video, a video segmentation grid applied over the video display window for identifying the location of selectable objects within the video being displayed, and different types of object identifiers;

FIG. 3 illustrates an embodiment of an image from the object identifiers of FIG. 2 that includes selectable objects that may be identified by cues and that are associated with additional information;

FIG. 4 illustrates an embodiment of a flow chart for implementing the video display systems described with respect to FIGS. 1, 2 and 3; and

FIG. 5 illustrates an embodiment of a computing system for implementing the systems and methods described herein.

### DETAILED DESCRIPTION OF ILLUSTRATIVE EMBODIMENTS

The present disclosure presents different systems and methods for identifying integrated objects, such as advertised items or other content, within media content, which may be sequitur or non-sequitur in nature, as further explained below, and more particularly presents the user with an integrated object selection solution to access information associated with the objects that does not interfere with the media in any meaningful way. The present disclosure will first be discussed in the context of video, and once that disclosure has been provided, a related disclosure for music will be provided. But, before discussing the integrated object identification or the integrated object selection, the nature of the video will first be described. The present disclosure may be used with mood-based video, as described in co-pending related U.S. patent application Ser. No. 13/828,656, filed Mar. 14, 2013, which is incorporated by reference herein, although it could be used with any other type of video content. Mood-based video as described herein is video content that is either created with a particular mood in mind to be conveyed to the viewer or which is not created with a particular mood in mind, but which upon being viewed is determined to clearly convey one or more moods.

In accordance with the present disclosure, the mood-based video may then be reviewed before the video is placed on a website for retail or other observation/consumption. During the review process, certain objects/items may appear in the video that may form the basis for an advertisement of some form, or some other type of metadata or information, such as trivia or educational information about that item. These identified items may or may not correspond to branded/identifiable items that happen to be the goods or services of a potential advertiser. If an identified item corresponds to a potential advertiser, the advertiser may be contacted, as noted above, to see if there is an interest in placing an advertisement in association with the identified item in the video, there was interest, then one or more of the processes described herein may be followed to mark the identified item to be advertised in the video and advertising content may be developed to be associated with the identified item, there was no advertising interest, or in the event there is a desire to associate information with the identified item for other reasons, other metadata may be associated with the identified item, such as trivia about that particular item, an advertisement for some other unrelated item (referred to herein as a non-sequitur advertisement, because the advertisement content does not logically follow the nature of the identified item), a game that the viewer could play, educational information about the item or the video content subject matter, a contest the viewer could participate in, a survey, or almost any other type of content, etc.

In addition, it may also be possible, depending on the cleverness of the pitch produced, to still entice a potential advertiser to place an advertisement in association with an identified item that is clearly not branded as theirs or which they did not produce. For example, a car could be shown in the video, or some other item, the brand or identity of which may or may not he discernible. If the car is a Toyota and Toyota is interested in advertising in association with that item in the video, then it could do so. However, that does not mean that a different car manufacture could not advertise in place of Toyota. Ford, for example, could place an advertisement in associate with a Toyota truck pictured in the video and draw the viewer's attention to their products in place of Toyota's products. If the make of the car or other item was not discernible, then naturally anyone could take the advertisement. Such advertisements would be sequitur advertisements that actually follow the nature of the item displayed. One reason why a sequitur advertisement may be placed by a brand owner or producer of the identified item relates to the processes by which advertisements are associated with the identified items as disclosed herein. Likewise, advertisements for completely unrelated information may also he placed with the objects, such as sunscreen, paint, insurance or a charity, each of which may or may not related to cars in some way. Non-sequitur advertisements are also made possible by the processes disclosed herein.

In order to identify the objects (also called items herein) to be marked and possibly advertised in some way, it is necessary to establish a system that makes it possible to accurately identify where items are located during the length of the video. Unlike still images, video content typically changes from frame to frame, such that during the length of a video, the amount of content displayed may be subject to both significant and frequently changes. The shorter the video, the more manageable it is to track and advertise the content illustrated in the video, so the present disclosure is ideally suited for videos of about five minutes or less, but could be used with video/film content of any length, such as television shows and fill length movies.

There are a number of techniques for advertising during a video, either by identifying and tagging objects displayed therein in some way, as further described below, or by simply placing advertising content (which may have nothing to do with the video content) over the video as it is displayed. The term “video overlay” generally refers to any technique used to display a video window on a computer display while bypassing the normal display process, i.e., central processing unit (CPU) to graphics card to computer monitor. This technique may be used to generate an additional interactive area over the video being displayed, such as an overlay advertisement, also known as a mid-roll overlay. Overlay advertising may be used in online video to monetize video content through using an overlay layer to deliver and display an advertisement unit. For example, an advertisement displayed on a webpage may include video showing a car being driven, and an overlay advertisement could be placed over the advertisement to encourage viewers to click on the overlay advertisement to learn more about the car being advertised in the video.

Video overlays may be created in various ways. Some techniques may involve connecting a video overlay device between the graphics card analog VGA output and the computer monitor's input, thereby forming a VGA pass-through. Such a device may modify the VGA signal and insert an analog video signal overlay into the picture, with the remainder of the screen being filled by the signal coming from the graphics card. Other video overlay devices may write the digital video signal directly into the graphics card's video memory or provide it to the graphics card's RAMDAC. Modern graphics cards are capable of such functionality without the need for overlay devices.

Hardware overlay is a technique implemented in modern graphics cards that may allow one application to write to a dedicated part of video memory, rather than to the part of the memory shared by all applications. In this way, clipping, moving and scaling of the image can be performed by the graphics hardware rather than by the CPU in software. Some solid state video recording systems include a hardware overlay, which may use dedicated video processing hardware built into the main processor to combine each frame of video with an area of memory configured as a frame buffer which may he used to store the graphics.

Overlay advertisements may be used to place advertisements over many free videos made available on the Internet, in an attempt by publishers of such video to monetize the video in some way. For example, 5min Media will provide free genre-based videos, generally related to instruction, knowledge, and lifestyle, to website operators to enable the website operators to add video to their website for very little money, 5min Media will then place advertisements in association with that video, either as a pre-roll (before the video starts), as an overlay, or in a variety of other traditional ways. The advertiser is charged a certain amount for each advertisement played in this manner, usually calculated as Cost Per Mille (CPM), which means a certain amount per 1000 views. As 5min Media is a syndication platform and does not produce the videos, it will then pay a certain CPM, generally a much smaller amount than that charged to the advertiser, to the content producer, and a larger GPM to the website operator for attracting the views.

Video networks, such as YOUTUBE and DECA will also associate overlay and other forms of advertisements on or in close association with video as it is displayed. DECA's KIN COMMUNITY video channel actually places a large banner overlay advertisement at the bottom of many videos that blocks some not insignificant portion of the video from being viewed.

A different form of video advertisement may be possible through hypervideo, or hyperlinked video, in which a displayed video stream is modified to contain embedded, user-clickable anchors, allowing navigation between the video and other hypermedia elements. Using hypervideo, a product placement may be placed in the video, or a contextual link, clickable graphic, or text may be used in the video to provide information related to the content of the video.

Hypervideo is similar to hypertext, which allows a reader to click on a word in one document and retrieve information from another document, or from another place in the same document, but is obviously more complicated due to the difficulties associated with moving versus static objects and something called node segmentation. Node segmentation refers to separating video content into meaningful pieces (objects in images) of linkable content. Humans are able to perform this task manually, but doing no is exceedingly tedious and expensive. At a frame rate of 30 frames per second, even a short video of 30 seconds comprises 900 frames, making manual segmentation unrealistic for even moderate amounts of video material. Accordingly, most of the development associated with hypervideo has focused on developing algorithms capable of identifying objects in images or scenes.

While node segmentation may be performed at the frame level, a single frame only contains still images, not moving video information. Hence, node segmentation is generally performed on scenes, which is the next level of temporal organization in a video. A scene can be defined as a sequential set of frames that convey meaning, which is also important because a hypervideo link generally needs to be active throughout the scene in which the item is displayed, but the scene before the item appears or the scene afterward when the item is no longer visible. Accordingly, hypervideo requires algorithms capable of detecting scene transitions, although other forms of hypervideo may use groups of scenes to form narrative sequences.

Regardless of the level of images within the video being analyzed, node segmentation requires objects to be identified and then tracked through a sequence of frames, which is known as object tracking. Spatial segmentation of objects can be achieved, through the use of intensity gradients to detect edges, color histograms to match regions, motion detection, or a combination of these and other methods.

Once the nodes have been segmented and associated with linking information, information such as metadata may be incorporated into the original video for playback. The metadata is typically placed in layers, or tracks, on top of the video; this layered structure is then presented to the user for viewing and interaction. Hypervideo may require special display technology, such as a hypervideo player, although VIDEOCLIX allegedly enables playback on standard players, such as QUICKTIME and FLASH, which are available for use through most browsers.

Hypervideo has been promoted as creating significant potential for commercial advertising because it offers an alternate way to monetize video, allowing for the possibility of creating video clips where objects link to advertising or e-commerce sites, or provide more information about particular products. This newer model of advertising is considered to be less intrusive because advertising information is only displayed when the user makes the choice by clicking on an object in a video. Since the user requested the product information, this type of advertising is considered to be better targeted and likely to be more effective.

Unfortunately, hypervideo has a number of shortcomings that may prevent it from realizing its full potential, without other solutions. Many consumers are not familiar with hypervideo and when exposed to a hypervideo do not realize that they can click on objects displayed in the video in order to see information about those objects. This remains the case even if banners or other notices are posted in association with the video indicating that object selection is possible. As a result, most viewers do not realize that they are being shown a video that has selectable objects and therefore do not select any objects, which defeats the purpose of the medium.

Even if they do realize they are viewing hypervideo and can select objects, which objects are selectable objects is not always clear, which lead users to clicking all over the video in an attempt to select any object that will react, which leads to two problems. First, if there are few selectable objects in a video scene and the viewer selects the wrong objects, the viewer may decide that the hypervideo is not working or become frustrated with how it works, which can result in the viewer's dissatisfaction with the provider of the hypervideo content. Second, when there are more selectable objects in a video scene, but the viewer is not patient enough to allow the computer system hosting the hypervideo to respond to the user's selections, the viewer may select a second object before a first object previously selected by the viewer has been able to respond, which results in the same problem as if there were too few objects to select.

A more significant issue relates to the speed at which videos can change scenes. Many videos are quite fast paced; especially shorter videos that attempt to convey a significant amount of information as fast as possible. As a result, even if a viewer was aware that they could click on objects within the video, by the time they react and grab or move their mouse and hit the selection button, the object may be gone. While some video producers might consider it a bonus to force the viewer to watch the video multiple times in order to get their timing down and select the object they want, most viewers will be less amused by this requirement. Finally, the reaction to the viewer's selection of an object during the playback of a video can be quite disruptive. In many cases, the video stops, so the advertisement can be played, while in others the advertisements, or at least text about the selected item is displayed over the video, blocking it from view, or is displayed next to the video as it is played, distracting the user from the video they are watching. This is true with respect to overlay techniques as well where selection of the overlay often results in a blocking action, a screen take over or a redirection to another website. If a viewer selected a number of different items during the course of a single view, the viewing experience and the enjoyment associated therewith may be adversely affected.

While the video playback and selection system disclosed herein may work with overlay techniques and a node segmentation object tracking-based system, there are simpler solutions described herein that could be utilized. For example, even if node segmentation is used to identify objects, a human is still required to identify what those objects are and to decide whether advertising could be associated with those objects, or even if the object identification is performed through some form of object recognition, a human will still be required to verify the selection that was made. Otherwise, a video publisher risks the potential for producing video content that wrongly identifies objects. A banana could easily be wrongly identified as a sex industry product and a view selecting a banana may be offered advertisements for sex items, when they should have been offered advertisements for a grocery store. Since humans are still going to be needed, no matter how much automation is attempted, the humans might as well do something more useful than distinguish fruit from other things.

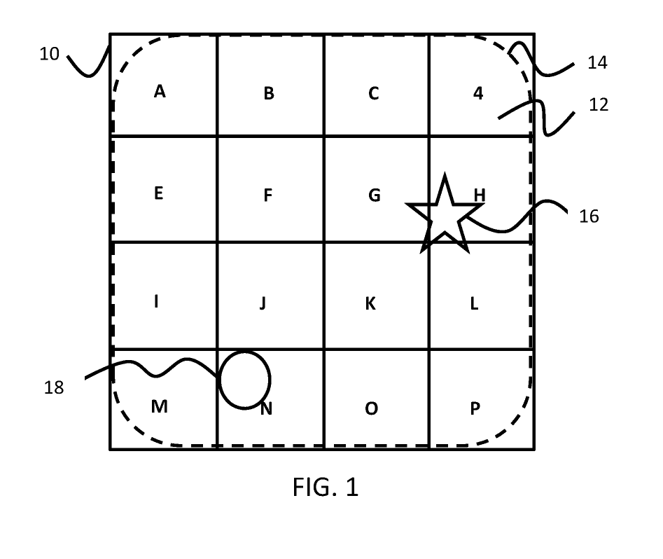

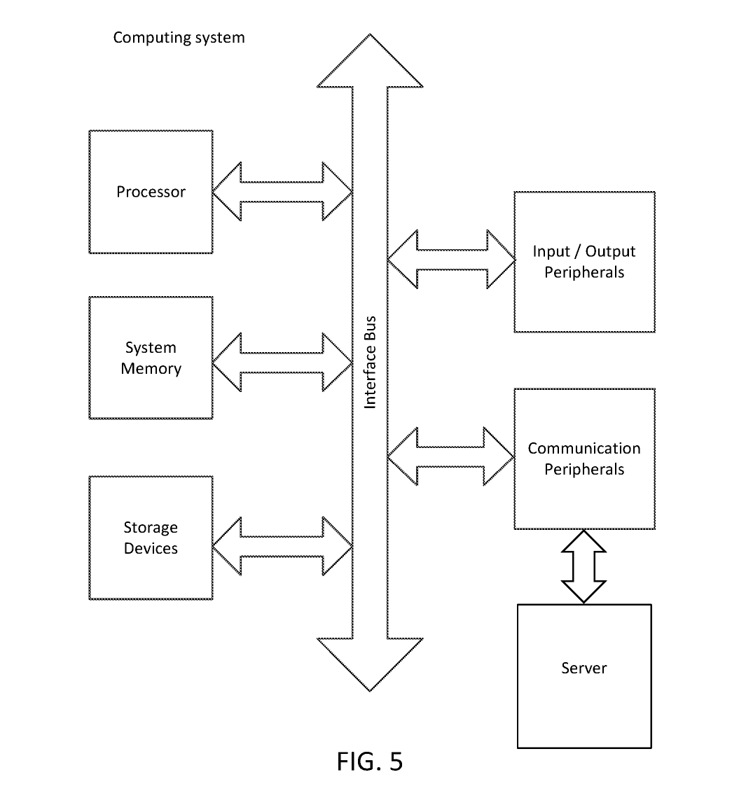

Accordingly, a reviewer of the video content would first need to view the video content and mark items or objects that are going to be selectable by subsequent viewers and have information associated with them. Hence, as shown in FIG. 1, video content is first accessed by the processor of a computer system so it can be displayed for review by a human, or an automated system, on a display screen of a computer system, such as a display screen included among the input/output peripherals of the computer system illustrated in FIG. 5. A user interface of the computer system may then be used to create an overlay on the review screen to accept input from a human user. The overlay may he a visible or invisible grid 10. The grid 10 may be placed over some or all of the content displayed on the video screen 14. The grid 10 serves to separate the video content's viewing screen into a number of different grid sections 12. The number of grid sections 12 may vary, with at least four grid sections 12 being sufficient for video with a lot of white space, and a larger number of grid sections 12, say 16 grid sections, possibly being necessary for busier or more populated video.

The grid 10 may be a visible grid that makes it possible for the reviewer to clearly see the grid placed over the video while the video is being played. In order to make the grid 10 visible to the user at all times, the computer system playing the video may sense the level of darkness associated with the video at the time the video is being played and adjust the color of the grid lines from black to white, or otherwise, in order to create sufficient contrast for the viewer between the grid 12 and the video content on the screen 14. The grid 10 may also be invisible such that it is not possible for the reviewer to see the grid while the video is being played. To familiarize the reviewer with the location of the grid sections of the grid 10, the grid may be made visible on the screen 14 prior to display of the video or periodically during the course of the video. Conversely, the grid 10 may not be displayed at all and the reviewer may just have a sense of where it would be if it were visible or even use a printed replica of the grid to remind the reviewer as to where it might be located if it were in use.

In order to identify the location of items within the video while the video is being played, the reviewer may use a finger, mouse or other pointing device to select different grid sections 12 that include items of interest during one or more periods of time during the video. This would have the effect of starting and stopping the identification of the location of an object or section of the video content. The speed at which the video is played may be modified to aid object identification. When the reviewer wished to stop identifying the item, the reviewer could once again select a section to indicate the reviewer had stopped. The starting and stopping sections may or may not be as a result of the same actions. For example, the reviewer could mark an item to be tracked as it first appears in one corner of the screen by selecting one or more appropriate grid sections 12, such as grid section A in the upper left corner, of grid 10 and marking the item again as it disappears from another corner of the screen by selecting a number corresponding to grid section p at the lower right corner of the screen 14 using a keyboard (another input/output device of the computer system of FIG. 5), or vice versa, or the reviewer may only use the keyboard to identify both grid sections. A and P, as well as other grid sections in between.

A touch screen system would make it possible for the user to simply use a finger to touch a grid section 12 when an object first appears and to touch other grid sections 12 as the object moves across the screen 14, or simply use their finger to follow the object around the screen thereby marking every section the object enters while the user's finger remains on the screen. In a 16 grid section review screen (with four grid sections across and four grid sections down lettered from left to right starting in the upper left corner), an object could enter at grid section C at one time, enter grid G at a second time, and exit at grid H at a third time, and all the reviewer would need to do is type C and time one, G at time two and H at time three, to mark the object. Alternatively, the reviewer may simply trace the object as the object moves around the screen or use voice recognition technology to state something like “car, C, start,” then “car, H, end” followed by “car, M, start” and “car, N, end,” etc. Such tracking instructions may indicate that the car entered the video at section C, moved to grid section H, and exited the screen, then reentered at grid section M and moved to section N where it again exited the screen. If the user was not identifying tracked objects, such as “car,” while the tracking was being executed, the identification may be accomplished later based on the tracking data that was created during the review, or even in advance if it was known that certain objects would be identified and tracked.

Likewise, if more than one object needed to be tracked during a scene, the reviewer could track multiple objects at once, or watch the video multiple times, tracking one object each time in order to track multiple objects. While there may be 900 frames in 30 seconds of video, it is still only 30 seconds of video, so the reviewer could watch the video numerous times without taking up too much time to do the review. This is another reason why shorter video pieces, of about 5 minutes or less may be more suitable for this type of effort.

In addition, certain types of image recognition technology may be used for similar purposes in order to automate the process of recognizing objects and making object identification more feasible for longer video. A car may be easy to recognize, so known image recognition analysis software may be able to analyze the video to identify a car and automatically track the car as it entered and exited the video, marking each segment along the way. Because video content is always marked by elapsed time as well, it is relatively simple to correlate the marked sections to the elapsed time and thereby provide an accurate correlation. To avoid the banana problem described above, it may be necessary to provide the image recognition technology with some limits as to the type of objects it is allowed to identify and track. Once the image recognition technology has made its initial passes at the video content, a human could do the same to supplement and/or correct what was recognized automatically.

As noted above, an example of an overlay grid-based integrated object identification and selection system is further illustrated in FIG. 1. The overlay grid 10 may be a 16 section grid comprised of a four by four equally sized layout of square grid sections 12. The grid 10 is placed over the viewing area 14 of a video display area, such as a screen on a computer monitor, a section of such a screen, a section of a web page, etc., that is playing a video to be reviewed. During the review, objects 16 and 18 may appear as part of the video for some period of time in one or more grid sections 12. While circular object 18 may only appear in grid section N, object 16 may appear split between the grid sections H and grid sections G, K and L, or move in between sections H, G, K and L. The reviewer may choose to identify all four sections, or just the one section that object 16 primarily appears to be in. Once all of the desired objects have been identified and tracked in this manner, the objects can be tagged or labeled based on the object type, the section and time, and possibly a sequence. For example if object 18 only appeared in section N at 0:45 of the video playback and disappeared from section N at 1:30 it might be identified and tracked as follows: circle; N;0:45-1:30. Similarly, star object 16 may enter section H and then travel in a counterclockwise direction for 30 seconds and be identified and tracked as follows: star; H;0:45-1:05; G;1:05-1:10; K;1:10-1:13; L;1:13-1:15. A wide variety of other identification and tracking solutions could be used. In addition, unidentified objects could be tracked first and then subsequently identified.

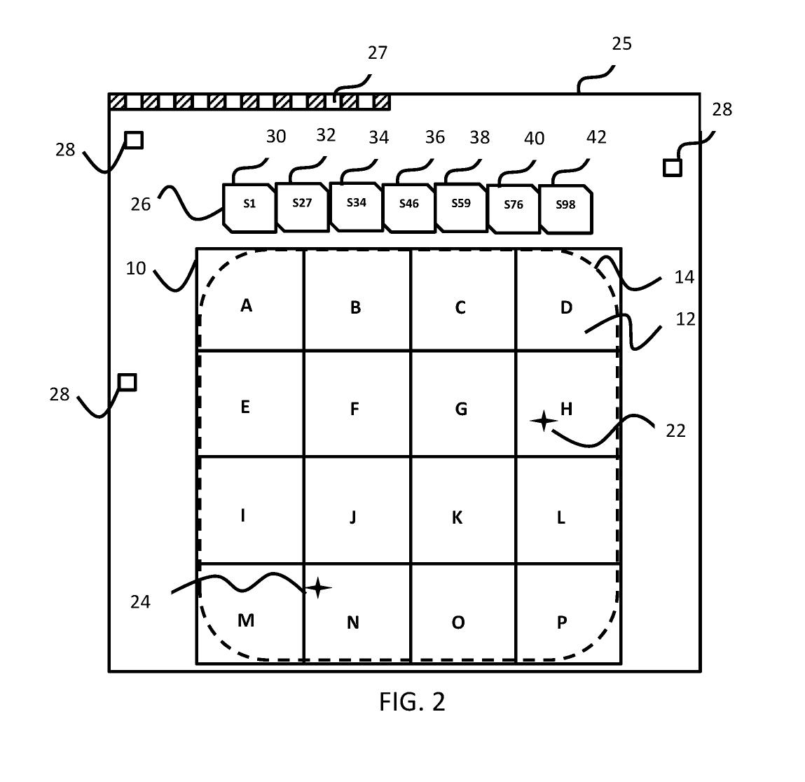

Once all of the objects to be tracked have been identified, those objects may need to be identified to viewers during playback in some easily recognizable manner that allows them to view the video without significant Obstruction as objects are identified to the viewer, and that allows the viewer to select the objects that are of interest to them. Regardless of the manner in which objects are identified and tracked, the object selection process needs to deal with the issues of identifying selectable objects and the speed at which objects appear during normal video playback, such that the viewer can identify all selectable objects, watch the video without significant disruption, and still see every advertisement or other form of information that might be of interest. A solution to the above identified problems may be illustrated in FIG. 2.

As the video starts, instead of having the user attempt to figure out whether the video is hypervideo or require the user to attempt to visually track objects and make selections, the video may provide visual cues to the user to indicate when a selectable object has appeared in the video. For example, as illustrated in FIG. 2, cue 22 in grid section H may indicate a first selectable object and cue 24 in grid section N may indicate a second selectable object in the same manner that star object 16 and circle object 18 indicated the Objects themselves in FIG. 1. In contrast, cues 22 and 24 may be “minimally” perceptible. The term “minimally perceptible” as used herein means that the cue is perceptible, either visually or aurally or both, by an amount of time, size and appearance that is sufficient enough for a viewer to recognize the cue for what it is and not think that the cue was part of the video content, but not more perceptible than that minimum. The minimum may be predetermined, hence a cue may be perceptible to a user by a predetermined minimum and be minimally perceptible to that user.

A visual cue may be in the form of a small little flash or shimmer that appears on the screen for a short period of time as the video is being played. If an aural cue is also played, the accompanying visual cue may be made perceptible by a first predetermined minimum and the aural cue may be perceptible by a second predetermined minimum, with the first predetermined minimum being less than the second predetermined minimum, as the aural cue serves a more important role in identifying the presence of a selectable object, regardless of whether the viewer is watching the video closely enough to perceive the visual cue. When an aural cue is not used, the visual cue may need to be displayed for a longer period of time, be brighter, be larger, etc., in order to draw the viewer's attention to the fact that a selectable object is being displayed. In some embodiments, the aural cue may be enough, without a visual cue, and in other embodiments, a visual cue of any size or form may be used by itself. In an embodiment, the visual cue is only visually perceptible by an amount (either in time, appearance or both) sufficient to catch a viewer's attention, but not so much as to detract from their enjoyment or ability to view the video.

The cue may appear when a selectable object first appears in the video, or after the object had been in the video for a predetermined period of time, or just before the object leaves the video, the entire time the object was depicted, or off and on (i.e., intermittently) while the object is depicted in the video. How long or how often the cue may be depicted depends on the cue's effectiveness and how it may be perceived from person to person. In some cases, the cue will not even be necessary (e.g., when object identifiers are used), but in some cases it may help to draw the viewer's attention to the object and to the fact that something different is going on with respect to the area of the video near that object.

As selectable Objects are depicted in the video, whether cues are used to highlight those objects or not, frames or scenes from the video that include depictions of those objects may be displayed in other sections of the viewing screen 25, such as a image bar 26. As illustrated in FIG. 2, the video content 14 is being displayed within a smaller window within the larger viewing area or screen 25 of a display so there is room for the image bar 26. Alternatively, the viewing content 14 could fill the entirety of viewing screen 25, which the image bar 27 being depicted as a very small graphic at the top or (or elsewhere within) the viewing screen 25. Although image bars 26 and 27 are referred to as image bars, meaning that they depict at least an image from the video in a line, the image bars may include only a single frame, a mixture of frames that do not necessarily form a scene, and a scene of frames. For simplicity, the image bars 26 and 27 will be referred to as an image bar whether it depicts a single frame, a series of frames or one or more scenes from the video. In addition, the image bars need not take the shape of a bar or line of images. The image bar 26 could be of any grouping of frames or scenes arranged in any contiguous shape or pattern or not contiguous at all, but rather comprised of a number of unconnected frames or scenes 28 purposely placed or scattered about the viewing area 25 of the screen.

The image bars 26 and 27 (or unconnected images 28), collectively referred to herein as “object identifiers,” may be populated as the selectable objects appear in the video, such that they simply pop up on the screen 25 as selectable objects appear in the video or as cues are depicted, perhaps growing in shape, size and pattern over time, or some visual motion may be used within the viewing area 14 to create the appearance of images leaving the video and becoming the object identifiers. For example, an overlay animation could be used to depict a minimally perceptible cue appearing in the video when a selectable object appears, with the cue floating across the screen, perhaps following the motion of the object in some way, and then moving to form an object identifier. Naturally, other methods of populating the object identifiers as the video is playing could be used, or the object identifiers could be populated before the video is played, after the video is played, or at some predetermined point while the video is being played. Obviously, the more linked the generation of the object identifiers is to the selectable objects appearing in the video, the more logical the object identifiers may feel to many viewers. For example, if the video included an image of a car at the beginning of the video, and a cue, such as cue 24 were to appear as the car entered the video, and then a motion occurred that illustrates the cue 24 moving to the object identifier (such as a replica or copy of the scene detaching from the viewing content 14 and floating up to the image bar 26 or 27 or some other object identifier 28), the viewer would have a clear indication that there was something about that object or scene or frame that was being highlighted in some way, even if the user did not understand exactly what all of that activity meant.

The first scene or frame containing a selectable object might then appear or otherwise be depicted in image 30 within the object identifiers, such as the image bar 26. The “S1” depicted within image 30 indicates that the image starts with frame 1 of the video, but the first image could start with any frame of the video. The remaining image 32-42 depict other scenes or frames containing selectable objects that might appear during different scenes or frames of a video, hence the different S numbers within the images indicating different scenes or frames in the video. There may only be one image 30 depicted in the image bar 26 or an unlimited number of images 30-42 and beyond, although depicting too many image may be problematic from a viewer selection perspective.

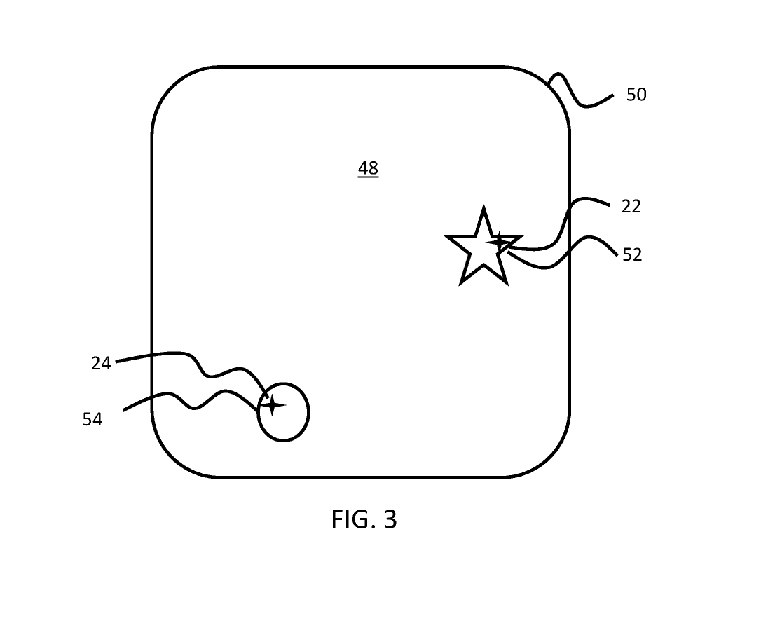

The identifiers may only be active after the video has finished, meaning that image may load into the object identifiers while the video is playing, but may not be accessible or otherwise capable of being viewed by the user until the video has completed, at which time the images, such as images 30-42, become accessible. Alternatively, at any time during the playback of the video, the viewer may select one of the image from the object identifiers If the user selected an image in the image bar 26 while the video was playing, the video may pause and the images in the video may be replaced with the selected image from the object identifier, which may play in a loop, or by an image that would be a still image, such as a single frame or a group of frames that could be manually paged through. Alternatively, the selected image may be displayed in a separate window, such as viewing window 50 of FIG. 3, from the rest of the video so the user may continue to watch the video in one window 14 and view images from an object identifier in another window 50 at the same time.

Regardless of how the user ends up viewing the image 48, such as presented in window 50 of FIG. 3 or in some other way, once presented to the user, the user may then select objects, such as objects 52 and 54, depicted within the image 48 until a selectable object responds appropriately, or more likely the viewer may be drawn to the selectable object or objects 52 and 54 by cues, such as cues 22 or 24. The cues would prevent the viewer from being forced to search through the image 48 looking for selectable objects by clicking on everything displayed with the image 48. Once the viewer has selected an object, whatever metadata that is purposely associated with that object may then be activated in some manner The selected object, such as object 54, may be a link to another site, or create a window or otherwise cause a visual object, such as an overlay, to appear that includes information somehow associated with that object. If an overlay is activated, it may appear over the image 48 or above or below the image 48, or displayed or performed in some way.

As previously noted, the activated information associated with an object may include sequitur and/or non-sequitur information, such as advertisements or other metadata as noted above, that is not otherwise included in the video, such as trivia or educational information about the selected object, a game or contest or something seemingly unrelated to the selected object, or something else. If the video content is targeted for a particular viewer audience, such as youths 17 years of age or younger, it may be important to tightly control the activated information, such that the viewer is not taken to an inappropriate website or displayed inappropriate information. If the video is being used for education purposes, as scenes are displayed and the image bar 26 is populated, the viewer may be able to select the object to learn more about what was being depicted in the image, what the object does or other information about it, be asked questions about what is being viewed, etc. Viewers may be rewarded in some way for correct answers or selecting enough objects or paging down through displayed textual information, etc.

This activated information, i.e., the advertisement, trivia or education information, games, or other metadata information, may or may not take the user in different directions. As noted above, if the video was directed to a youth-based market, the activated information may take the youth to a different page within the website playing the video, so that the youth did not have access to or was not directed to the Internet as a whole, but just that page or website, as is possible with various Internet blocking software applications. Alternatively, the activated information could take the user to approved sites based on various website ranking or filter systems. If an advertisement was associated with the activated information and the advertisement was appropriate for the age grouping of the viewers of the website, the viewers may be directed to the third party website, based on the assumption that any parental controls employed on the viewer's computer would take control if necessary.

When the activated information is not youth-related, then anything could happen as a result of the viewer selecting a selectable objected within a scene 30-42. The user could be directed to any other page or website related to the activated information so as to be exposed to other information, advertisements, or the like.

As an alternative to the selection system or methods described above in association with the object identifier, such as image bar 26, or identifying objects within the video or display area 14, object selection during the viewing of a video could be less refined. For example, instead of having the object activated for selection, the same grid system described above may be used for object selection purposes. Hence, as long as a viewer selected a grid section corresponding to the location of a selectable object, the object would behave as though it had been activated and everything else would behave in the manner described above. This solution simplifies the process of identifying the area around an object that makes it selectable and reduces the cost of activating objects overall. The only limitation associated with this solution is that two objects within the same grid section could not be separately activated, but since the content of the video is moving, this problem may generally be solved by just picking grid sections for display that include the objects in separate grid sections.

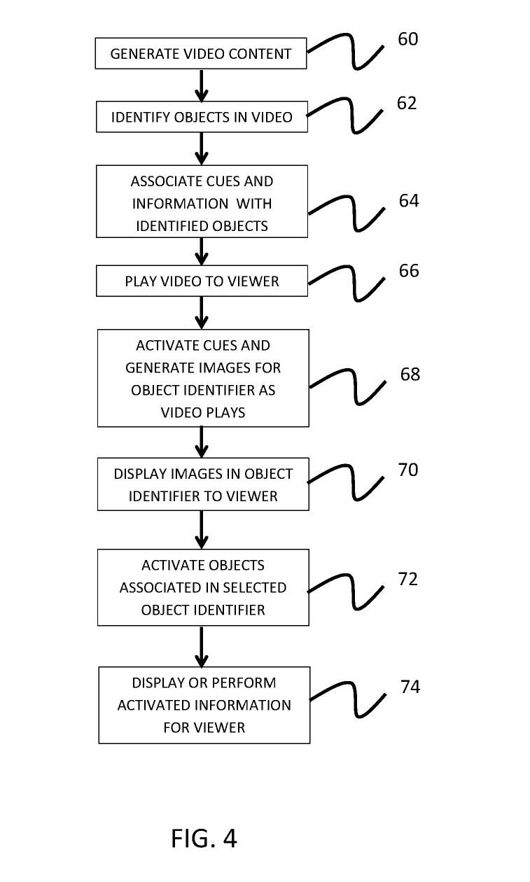

The methods corresponding to the above systems are depicted in FIG. 4, and supplemented in detail by the systems described above. In step 60, the video content that is going to be displayed to a user is generated or displayed. As described above, such video content may be mood-based and of a limited duration, on the order of five minutes or so and less, or longer. The video content may also be targeted for a specific audience, such as youths. Once the video content has been generated, certain objects within the video content that are going to be activated later, will be identified, step 62. The identified objects may be manually selected, identified through node segmentation, identified through image recognition analysis algorithms, and a variety of other systems. The objects may be identified using the visible or invisible grid systems described herein, including the different methods by which a review identifies objects and grid sections corresponding to the objects' appearances in the video.

Once the objects have been identified, cues may be associated with the identified objects, step 64. As noted above, the cue may be visual, aural, a combination of both. In addition, the information (metadata or other information) to be associated with identified/selectable objects may be associated with the identified objects at this time (such association may be performed later as well). As previously noted, the cues may be minimally perceptible to the viewer or otherwise adapted to fit the content being played. As the video plays to the viewer, step 66, the images for the image bar or other form of object identifier are automatically generated, step 68, so as to simplify the user's actions needed to select objects in the video. Depending on the identifier display system chosen, the images of the object identifier may be displayed, step 70, during the playback of the video or after the playback of the video.

Regardless, of how the object identifier is displayed to the viewer, the viewer will eventually be presented with the opportunity to view the frames/scenes associated with an object identifier containing the identified objects and will be able to activate those objects for further information, step 72. Such activation may be through selecting the object itself within a frame or scene or selecting a grid section within which the identified object is displayed. Once the object has been selected by the viewer, the activated information would then be displayed or otherwise provided to the user Of just aural information), step 74.

In each embodiment, one or more computers, such as illustrated in FIG. 5, may include non-transitory system memory, a processor, storage devices, input/output peripherals, including user interfaces, which may be graphical or aural or both, and communications peripherals, which may all be interconnected through one or more interface buses or other networks. The non-transitory memory, the processor and the user interface may be part of one computer that is then accessed by a user over a network from other computers, such as over the World Wide Web of the Internet or some other network, through a client-server arrangement, or some other arrangement by which it is not necessary for the user to have the content stored on the user's computer for the user to have access to the content, to assign moods to the content, to search the content based on moods, to view videos or scenes or frames, or to interact with activated information.

The descriptions of computing systems described herein are not intended to limit the teachings or applicability of this disclosure. Further, as noted above, the processing of the various components of the illustrated systems may be distributed across multiple machines, networks, and other computing resources. For example, each operative module of the herein described system may be implemented as separate devices or on separate computing systems, or alternatively as one device or one computing system. In addition, two or more components of a system may be combined into fewer components. Further, various components of the illustrated systems may be implemented in one or more virtual machines, rather than in dedicated computer hardware systems. Likewise, the data repositories shown may represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown may communicate with any other subset of components in various implementations.

Depending on the embodiment, certain acts, events, or functions of any of the methods described herein may be performed in a different sequence, may be added, merged, or left out altogether (e.g., not all described acts or events are necessary for the practice of the algorithms). Moreover, in certain embodiments, acts or events may be performed concurrently, e.g., through multi-threaded processing, interrupt processing, or multiple processors or processor cores or on other parallel architectures, rather than sequentially.

The techniques described above can be implemented on a computing device associated with a user (e.g., a viewer, a reviewer, or any other persons described herein above). In an embodiment, the user may be a machine, a plurality of computing devices associated with a plurality of users, a server in communication with the computing device(s), or a plurality of servers in communication with the computing device(s). Additionally, the techniques may be distributed between the computing device(s) and the server(s). For example, the computing device may collect and transmit raw data to the server that, in turn, processes the raw data to generate activated information, video content, scenes, frames, etc. FIG. 5 describes a computing system that includes hardware modules, software module, and a combination thereof and that can be implemented as the computing device and/or as the server.

The interface bus of the computing system may be configured to communicate, transmit, and transfer data, controls, and commands between the various components of the personal electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

Each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state. Each method described herein may be implemented by one or more computing devices, such as one or more physical servers accessible through the communication peripherals or other networks, programmed with associated server code.

Further, the input and output peripherals include user interfaces such as a keyboard, display screen, microphone, speaker, other input/output devices, and computing components such as digital-to-analog and analog-to-digital converters, graphical processing units, serial ports, parallel ports, and universal serial bus. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface that the user can use to provide input to the computing system and to receive an output from the computing system. This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The methods and algorithms associated therewith may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks or steps may be omitted in some implementations. The methods described herein are also not limited to any particular sequence, and the blocks or steps relating thereto can be performed in other sequences that are appropriate. For example, described blocks or steps may be performed in an order other than that specifically disclosed, or multiple blocks or steps may be combined in a single block or step. The example blocks or steps may be performed in serial, in parallel, or in some other manner. Blocks or steps may he added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

In an embodiment, a computer-implemented method for identifying objects depicted within a video comprises utilizing a processor of a computer to access and display the video; accepting through an interface of the computer one or more locations of one or more identified objects depicted in the video, wherein the interface includes a grid overlaid on at least a portion of a display screen of the computer, and wherein each identified objects is depicted in a set of one or more locations corresponding to one or more grid sections of the grid; for each identified object, associating with the processor the identified object with the set of one or more locations and a period during the video that the identified object is depicted in the set of one or more locations; and associating with the processor sequitur or non-sequitur information not included in the video with each identified object.

In the embodiment, wherein the grid is a visible grid, a non-visible grid or a partially visible grid and a partially non-visible grid. In the embodiment, wherein accepting includes accepting input from a human user through the interface of the computer the one or more locations, wherein the input includes the human user's tracking of each identified object. In the embodiment, wherein the human user's tracking of each identified object includes specified grid sections in which each identified object is depicted during the period. In the embodiment, wherein the display screen is a touch screen and the specified grid sections are specified by the human user's touching of the specified grid sections. In the embodiment, wherein associating with the processor the identified object further includes associating the identified object with an object type. In the embodiment, wherein the sequitur or non-sequitur information includes one or more of an advertisement, trivia, educational information, a link to another location, a game or a contest.

In the embodiment, further comprising generating with the processor one or more cues for each identified object, wherein the one or more cues are provided to a viewer of the video to identify each identified object as a selectable object. In the embodiment, wherein the one or more cues have a predetermined minimum of perceptibility to the viewer. In the embodiment, wherein the one or more cues includes a first cue with a first predetermined minimum of perceptibility to the viewer and a second cue with a second predetermined minimum of perceptibility to the viewer, wherein the first predetermined minimum of perceptibility to the viewer is less than the second predetermined minimum of perceptibility to the viewer. In the embodiment, wherein the first cue is aural and the second cue is visual. In the embodiment, wherein the one or more cues include visible cues that are overlaid on the video as the video is played on a viewer screen, and wherein a position on the viewer screen of each of the one or more cues as the video is played to the viewer corresponds to the set of one or more locations for each identified object. In the embodiment, wherein the one or more cues include visible cues that are overlaid on the video as the video is played on a viewer screen, wherein a position on the viewer screen of each of the one or more cues as the video is played to the viewer corresponds to a portion of the set of one more locations for each identified object, and wherein the portion is based on one or more of a first period to time during which the identified object first appears in the video, a second period of time during prior to when the identified object disappears in the video, or a third period of time that intermittently corresponds to depiction of the identified object in the video.

In the embodiment, further comprising generating with the processor one or more object identifiers on a viewer screen as the one or more cues are generated. In the embodiment, wherein the one or more object identifiers are displayed in a contiguous group and form a shape or pattern. In the embodiment, wherein the one or more object identifiers are not physically connected. In the embodiment, wherein each of the one or more object identifiers include one or more frames from the video depicting the identified object during the period. In the embodiment, wherein each of the one or more frames form a scene. In the embodiment, wherein the one or more cues include visible cues, and wherein each visible cue is transformed by the processor to an object identifier among the one or more object identifiers. In the embodiment, wherein transformation of a visible cue to the object identifier is animated.

In the embodiment, further comprising displaying the one or more frames to the viewer on the viewer screen in response to an object identifier being selected by the viewer; and providing the sequitur or non-sequitur information to the viewer in response to an identified object depicted in the one or more frames being selected by the viewer. In the embodiment, wherein the sequitur or non-sequitur information includes one or more of an advertisement, trivia, educational information, a link to another location, a game or a contest. In the embodiment, wherein providing the sequitur and non-sequitur information includes generating with the processor a visible cue corresponding to the identified object with the one or more frames.

In an embodiment, a computer-implemented method for identifying objects depicted within a video comprises utilizing a processor of a computer to access and display the video; accepting input to the processor from an image recognition system analyzing the video one or more locations of one or more identified objects depicted in the video, wherein each identified objects is depicted in a set of one or more locations corresponding to one or more sections of a display screen on which the video is displayable; for each identified object, associating with the processor the identified object with the set of one or more locations and a period during the video that the identified object is depicted in the set of one or more locations; and associating with the processor sequitur or non-sequitur information not included in the video with each identified object.

In the embodiment, wherein the image recognition system tracks each identified object as the identified object is depicted in the video to determine the set of one or more locations. In the embodiment, wherein associating with the processor the identified object further includes associating the identified object with an object type. In the embodiment, wherein the sequitur or non-sequitur information includes one or more of an advertisement, trivia, educational information, a link to another location, a game or a contest.

In the embodiment, further comprising generating with the processor one or more cues for each identified object, wherein the one or more cues are provided to a viewer of the video to identify each identified object as a selectable object. In the embodiment, wherein the one or more cues have a predetermined minimum of perceptibility to the viewer. In the embodiment, wherein the one or more cues includes a first cue with a first predetermined minimum of perceptibility to the viewer and a second cue with a second predetermined minimum of perceptibility to the viewer, wherein the first predetermined minimum of perceptibility to the viewer is less than the second predetermined minimum of perceptibility to the viewer. In the embodiment, wherein the first cue is aural and the second cue is visual. In the embodiment, wherein the one or more cues include visible cues that are overlaid on the video as the video is played on a viewer screen, and wherein a position on the viewer screen of each of the one or more cues as the video is played to the viewer corresponds to the set of one or more locations for each identified object. In the embodiment, wherein the one or more cues include visible cues that are overlaid on the video as the video is played on a viewer screen, wherein a position on the viewer screen of each of the one or more cues as the video is played to the viewer corresponds to a portion of the set of one more locations for each identified object, and wherein the portion is based on one or more of a first period to time during which the identified object first appears in the video, a second period of time during prior to when the identified object disappears in the video, or a third period of time that intermittently corresponds to depiction of the identified object in the video.

In the embodiment, further comprising generating with the processor one or more object identifiers on a viewer screen as the one or more cues are generated. In the embodiment, wherein the one or more object identifiers are displayed in a contiguous group and form a shape or pattern. In the embodiment, wherein the one or more object identifiers are not physically connected. In the embodiment, wherein each of the one or more object identifiers include one or more frames from the video depicting the identified object during the period. In the embodiment, wherein each of the one or more frames form a scene. In the embodiment, wherein the one or more cues include visible cues, and wherein each visible cue is transformed by the processor to an object identifier among the one or more object identifiers. In the embodiment, wherein transformation of a visible cue to the object identifier is animated.

In the embodiment, further comprising displaying the one or more frames to the viewer on the viewer screen in response to an object identifier being selected by the viewer; and providing the sequitur or non-sequitur information to the viewer in response to an identified object depicted in the one or more frames being selected by the viewer. In the embodiment, wherein the sequitur or non-sequitur information includes one or more of an advertisement, trivia, educational information, a link to another location, a game or a contest. In the embodiment, wherein providing the sequitur and non-sequitur information includes generating with the processor a visible cue corresponding to the identified object with the one or more frames.

In an embodiment, a computer-implemented method for identifying selectable objects depicted within a video to a viewer comprises utilizing a processor of a computer to access and display the video, wherein one or more locations of one or more objects depicted within the video have been identified, wherein each identified objects is depicted in a set of one or more locations corresponding to one or more sections of a viewer screen on which the video is displayed, wherein each identified object has been associated with the set of one or more locations and a period during the video that the identified object is depicted in the set of one or more locations, and wherein each identified object has been associated with sequitur or non-sequitur information not included in the video; generating with the processor one or more cues for each identified object, wherein the one or more cues are provided to a viewer of the video to identify each identified object as a selectable object; generating with the processor one or more object identifiers on a viewer screen as the one or more cues are generated, wherein each of the one or more object identifiers include one or more frames from the video depicting the identified object during the period; displaying the one or more frames to the viewer on the viewer screen in response to an object identifier being selected by the viewer; and providing the sequitur or non-sequitur information to the viewer in response to an identified object depicted in the one or more frames being selected by the viewer.

In the embodiment, wherein the one or more cues have a predetermined minimum of perceptibility to the viewer. In the embodiment, wherein the one or more cues includes a first cue with a first predetermined minimum of perceptibility to the viewer and a second cue with a second predetermined minimum of perceptibility to the viewer, wherein the first predetermined minimum of perceptibility to the viewer is less than the second predetermined minimum of perceptibility to the viewer. In the embodiment, wherein the first cue is aural and the second cue is visual. In the embodiment, wherein the one or more cues include visible cues that are overlaid on the video as the video is played on a viewer screen, and wherein a position on the viewer screen of each of the one or more cues as the video is played to the viewer corresponds to the set of one or more locations for each identified object. In the embodiment, wherein the one or more cues include visible cues that are overlaid on the video as the video is played on a viewer screen, wherein a position on the viewer screen of each of the one or more cues as the video is played to the viewer corresponds to a portion of the set of one more locations for each identified object, and wherein the portion is based on one or more of a first period to time during which the identified object first appears in the video, a second period of time during prior to when the identified object disappears in the video, or a third period of time that intermittently corresponds to depiction of the identified object in the video.

In the embodiment, wherein the one or more object identifiers are displayed in a contiguous group and form a shape or pattern. In the embodiment, wherein the one or more object identifiers are not physically connected, :1n the embodiment, wherein each of the one or more frames form a scene. In the embodiment, wherein the one or more cues include visible cues, and wherein each visible cue is transformed by the processor to an object identifier among the one or more object identifiers. In the embodiment, wherein transformation of a visible cue to the object identifier is animated. In the embodiment, wherein the sequitur or non-sequitur information includes one or more of an advertisement, trivia, educational information, a link to another location, a game or a contest. In the embodiment, wherein providing the sequitur and non-sequitur information includes generating with the processor a visible cue corresponding to the identified object with the one or more frames.

While certain example embodiments have been described, these embodiments have been presented by way of example only, and are not intended to limit the scope the disclosures herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the disclosures herein. The accompanying claims and their equivalents are intended to cover such forms or modifications as would fall within the scope and spirit of certain of the disclosures herein.

What is claimed:

1. A computer-implemented method for identifying selectable objects depicted within a video to a viewer, comprising:
utilizing a processor of a computer to access and display the video, wherein one or more locations of one or more objects depicted within the video have been identified, wherein each identified object is depicted in a set of one or more locations corresponding to two or more sections of a viewer screen on which the video is displayed, wherein each identified object has been associated with the set of one or more locations and a period during play of the video that the identified object is depicted in the set of one or more locations, and wherein each identified object has been associated with sequitur or non-sequitur information;
generating with the processor one or more object identifiers on a viewer screen as the one or more cues are generated, wherein each of the one or more object identifiers include one or more frames from the video depicting the identified object during the period;
displaying the one or more frames to the viewer on the viewer screen in response to an object identifier being selected by the viewer; and
providing the sequitur or non-sequitur information to the viewer in response to an identified object depicted in the one or more frames being selected by the viewer.

2. The method of claim 1, further comprising:
generating with the processor one or more cues for each identified object, wherein the one or more cues are provided to a viewer of the video to identify each identified object as a selectable object;

3. The method of claim 2, wherein the one or more cues have a predetermined minimum of perceptibility to the viewer.

4. The method of claim 3, wherein the one or more cues includes a first cue with a first predetermined minimum of perceptibility to the viewer and a second cue with a second predetermined minimum of perceptibility to the viewer, wherein the first predetermined minimum of perceptibility to the viewer is less than the second predetermined minimum of perceptibility to the viewer.

5. The method of claim 4, wherein the first cue is aural and the second cue is visual.

6. The method of claim 2, wherein the one or more cues include visible cues that are overlaid on the video as the video is played on a viewer screen, and wherein a position on the viewer screen of each of the one or more cues as the video is played to the viewer corresponds to the set of one or more locations for each identified object.

7. The method of claim 2, wherein the one or more cues include visible cues that are overlaid on the video as the video is played on a viewer screen, wherein a position on the viewer screen of each of the one or more cues as the video is played to the viewer corresponds to a portion of the set of one more locations for each identified object, and wherein the portion is based on one or more of a first period to time during which the identified object first appears in the video, a second period of time during prior to when the identified object disappears in the video, or a third period of time that intermittently corresponds to depiction of the identified object in the video.

8. The method of claim 7, wherein the one or more object identifiers are displayed in a contiguous group and form a shape or pattern.

9. The method of claim 7, wherein the one or more object identifiers are not physically connected.

10. The method of claim 1, wherein the one or more cues include visible cues, and wherein each visible cue is transformed by the processor to an object identifier among the one or more object identifiers.

11. The method of claim 10, wherein transformation of a visible cue to the object identifier is animated.

12. The method of claim 1, wherein the sequitur or non-sequitur information includes one or more of an advertisement, object metadata, trivia, educational information, a link to another location, a game or a contest.

13. The method of claim 1, wherein providing the sequitur and non-sequitur information includes generating with the processor a visible cue corresponding to the identified object with the one or more frames.

14. The method of claim 1, wherein each of the one or more frames form a scene.
